(19) United States
(12) Patent Application Publication
(10) Pub. No.: US 2008/0209136 A1
(43) Pub. Date: Aug. 28, 2008

(54) SYSTEM AND METHOD OF STORAGE SYSTEM ASSISTED I/O FENCING FOR SHARED STORAGE CONFIGURATION

(76) Inventors: Yanling Qi, Austin, TX (US); Scott W. Kirvan, Austin, TX (US)

Correspondence Address: LSI CORPORATION, 1621 BARBER LANE, MS: D-106, MILPITAS, CA, 95035, US

(21) Appl. No.: 11/680,449

(22) Filed: Feb. 28, 2007

(51) Int. Cl. G06F 13/00

(52) U.S. Cl. 711/148

(57) ABSTRACT

Systems and methods for improved I/O fencing for shared storage in a clustered or grid computing environment. I/O fencing is performed with aid from the storage system and an I/O fencing management client process. The client process detects changes in the operational status of any of the clustered computing nodes. Upon sensing a change from a functional state to a dysfunctional state, the management client process effectuates reconfiguration of the storage system to disallow potentially destructive access by the dysfunctional node to the shared storage volumes. Upon sensing resumption of a functional status for the dysfunctional node, the client effectuates reconfiguration of the storage system to again allow desired access to the shared storage volumes by the now functional node. The client and storage system may share access to a database maintained by the client indicating the shared volumes a node may access and the initiators associated with each node.

### BACKGROUND

1. Field of the Invention

The invention relates generally to an enterprise comprising shared storage systems coupled to clustered computing nodes and more specifically relates to improved systems and methods for I/O fencing in such an enterprise.

2. Discussion of Related Art

Server clustering and grid computing combined with utility storage are the solution of choice in a growing number of compute intensive problem spaces. The system architecture in these types of computing environments features a potentially large number of computing nodes cooperating under the guidance of clustering or grid management software or systems.

The computing cluster or grid is typically coupled to shared utility storage through a storage area network (“SAN”) communication architecture. To implement grid computing and utility storage, a number of relatively inexpensive computers are typically connected together. These computers are usually called cluster nodes or just nodes. The nodes typically share data storage using a SAN coupling the nodes to the storage system(s). Various known technologies are employed to ensure data integrity including network based distributed lock managers and disk based distributed lock managers. Should any given node or group of nodes become dysfunctional, the failed node/nodes must be isolated from the computing environment. Specifically, they must not be allowed to access SAN resources in any potentially destructive manner until they are restored to normal operating condition. Otherwise, the dysfunctional nodes could corrupt shared data in the shared storage system(s).

It is generally known in the art to provide a method in the enterprise for denying access to shared storage resources by malfunctioning computing nodes in a multi-node computing environment. As presently practiced, in general, when a clustered/grid system detects that a computing node is not behaving appropriately, it uses a management user interface in the enterprise to deny the failed computing node or nodes access to one or more storage systems. The storage system (systems) then rejects I/O requests from the specified computing node or nodes. The general term for this technology is “I/O fencing”. When the failure condition in the computing node/nodes is corrected, the cluster management system or software commands the storage system (or systems) to resume I/O processing for the previously failed computing node/nodes. Storage systems on the SAN may be visible to a malfunctioning node but write or read/write access to shared storage systems will be denied while the I/O fencing methods indicate that the computing node is in a suspect or failed state.

Various types of failures could potentially prevent nodes of the cluster/grid from being able to coordinate their access to shared storage. Three common failure types are: 1) Network interface card (NIC), communication interface failure for the communication link coupling each of the nodes together; 2) “Split brain”-disconnected cluster partitions such that subsets of nodes are operable but cannot communicate with the other subsets; and 3) Erratic server behavior.

In general, the nodes of the cluster or grid are coupled through respective network interface cards (NIC) and an associated communication medium. InfiniBand is another common medium and protocol for coupling the nodes of the cluster/grid. This coupling defines a “private network” connection among the co-operating nodes of the cluster/grid allowing the exchange of cluster coordination and management information among cluster nodes. A failure of any one of these cards could mean the node is fully capable of writing to shared storage even though it can no longer coordinate access with other nodes. The node with the failed private network connection must be prevented from writing to the shared storage system until access to the private network is restored. It may be allowed, however, to continue to write to its own local file systems or non-shared storage devices on the SAN such as a private SAN boot device.

So-called “split-brain” scenarios arise when a network failure cuts off some group of nodes from the rest of the cluster, but both groups can still access shared storage. The two groups cannot communicate to each other, but each can still reach the shared storage. Because the two groups cannot coordinate storage access, only one of the groups should be allowed continued access to the shared data storage.

Finally, a node itself may fail. The simple case is a complete failure that takes the node off-line. The cluster management software or system may detect this and the failed node's applications are moved to a surviving node. A more complicated case is a node that becomes erratic or unreliable and is therefore unable to participate in storage access coordination. Such a node must be excluded from the cluster and prevented from accessing the shared storage.

Currently a number of I/O fencing methods are known to exclude a dysfunctional node from accessing shared storage. One such method is often referred to by the acronym “STOMITH” (“Shoot the Other Machine in the Head”). The STOMITH approach uses a network-controlled power switch to cut off a dysfunctional node's power supply when it is no longer deemed to be a reliable member of the cluster. Since a node's power supply is cut, the unreliable node no-longer can access the shared storage system. Another approach often referred to as “fabric fencing” uses a Fibre Channel or network switch's management interface to disable the switch port/ports through which the offending node is attached to the SAN. Since the offending node's access to the SAN is thus disabled, it is no longer able to access shared storage. Yet another approach uses SCSI3 standard commands such as Persistent Reservation commands to allow an identified set of SCSI initiators to access a logical unit of a storage system but deny other initiators access. Thus the Persistent Reservation commands may allow all properly functioning nodes to access the shared storage but deny access to any node presently in a failed or suspect state.

There are disadvantages in each of these known approaches. As regards the STOMITH approach, suddenly powering off a computer may cause a computer hardware failure. Further, most critical computer systems today usually provide an Uninterruptible Power Supply (UPS) back-up power to prevent a system from unexpectedly losing power thus rendering the STOMITH solution more difficult to implement. Even assuming the power can be shut off, another problem may arise in that system administrators can not trouble-shoot the root cause of the node failure after it is suddenly turned off. If the administrator restarts the node, the same problem may happen again and the functional nodes in the cluster may again “shoot” the offending system down. With the “fabric fencing” approach, the node's connection to the SAN is disabled by sending commands to the switch coupling the node to the storage system. Every switch works differently as regards such a management function. Thus the cluster management software or system would require detailed knowledge of the vendor and model of each SAN switch in the enterprise and may have to provide different commands or interfaces to each particular switch. Another problem with the fabric fencing approach is that if the node is a diskless computer and is booted from a storage device (a private device) provided by the SAN storage system, fabric fencing will make the node unable to reach its boot device. As for use of SCSI3 Persistent Reservation commands, Persistent Reservations are a good access control model for allowing a small number of initiators to access a specified storage device. However the solution is cumbersome and impractical for excluding one initiator or a few initiators while allowing a different (potentially large) set of initiators continued access to a storage device.

It can be seen from the above discussion that a need exists for improved systems and methods to provide I/O fencing in such clustered/grid computing environments.

### Solution

The invention solves the above and other problems, thereby advancing the state of the useful arts, by providing systems and methods for I/O fencing implemented with aid of the storage system. Features and aspects hereof provide systems and methods for detecting a change in the operational state of a computing node of the cluster and for effectuating reconfiguration of the storage system to disallow or allow access by the associated node to shared storage volumes based on the changed status.

In one aspect hereof a system is provided, that includes a cluster comprising a plurality of computing nodes communicatively coupled to one another and a storage system comprising a plurality of shared volumes. The cluster and storage system are coupled by a storage area network (“SAN”) communication channel. The system also includes a database comprising information regarding shared volumes in the storage system and comprising information regarding the plurality of computing nodes. The system includes a collaboration management process associated with the cluster and associated with the storage system and coupled to the database. The collaboration management process is adapted to sense a change of the operational state of a computing node of the cluster and is further adapted to update the database to indicate which shared volumes are accessible to each of the plurality of computing nodes. The storage system is communicatively coupled to the database and wherein the storage system is adapted to allow and disallow access to a shared volume by a particular computing node based on information in the database.

In another aspect, a method is provided. The method is operable in a cluster computing enterprise, the enterprise including a cluster of computing nodes each coupled to a storage system, the storage system comprising a plurality of shared volumes controllably accessible by the cluster of computing nodes. The method includes detecting failure of a computing node of the cluster and updating a table accessible by the storage system to indicate the failed status of the computing. The method then disallows access by the failed computing node to the shared volumes of the storage system based on updated information in the table.

Yet another aspect hereof provides a method operable in a system including a storage system coupled to a cluster of computing nodes, the storage system including a plurality of shared volumes. The method includes generating a node-volume table wherein each entry in the node-volume table corresponds to a computing node of the cluster and wherein the entry further indicates the shared volumes to which the node-volume table entry's corresponding computing node requires access. The method also generates a node-initiator table stored in the storage system wherein each entry in the node-initiator table corresponds to a computing node of the cluster and wherein each entry further indicates all initiator devices associated with the corresponding computing node used by the node-initiator table entry's corresponding computing node to communicate with the storage system. The method detects the operating status of a computing node of the cluster. Responsive to detecting failed operating status of a previously functional computing node of the cluster, the method configures the storage system to disallow access to one or more shared volumes of the storage system by any initiator devices associated with the now dysfunctional computing node. Responsive to detecting resumption of normal operating status of a previously dysfunctional computing node of the cluster, the method configures the storage system to allow access to one or more shared volumes of the storage system by any initiator devices associated with the now functional computing node. The method steps of configuring utilize information in the node-initiator table and utilize information in the node-volume table.

### BRIEF DESCRIPTION OF THE DRAWINGS

FIG. 1 is a block diagram of an exemplary system in accordance with features and aspects hereof to provide improved I/O fencing management in a clustered computing environment with shared storage volumes.

FIG. 2 is a flowchart describing an exemplary method in accordance with features and aspects hereof to provide enhanced I/O fencing management in a clustered computing environment with shared storage volumes.

FIG. 3 is a flowchart describing another exemplary method in accordance with features and aspects hereof to provide enhanced I/O fencing management in a clustered computing environment with shared storage volumes.

FIGS. 4 and 5 are flowcharts of exemplary methods in accordance with features and aspects hereof generally operable in a storage system to provide improved I/O fencing management in cooperation with a management client process.

### DETAILED DESCRIPTION OF THE DRAWINGS

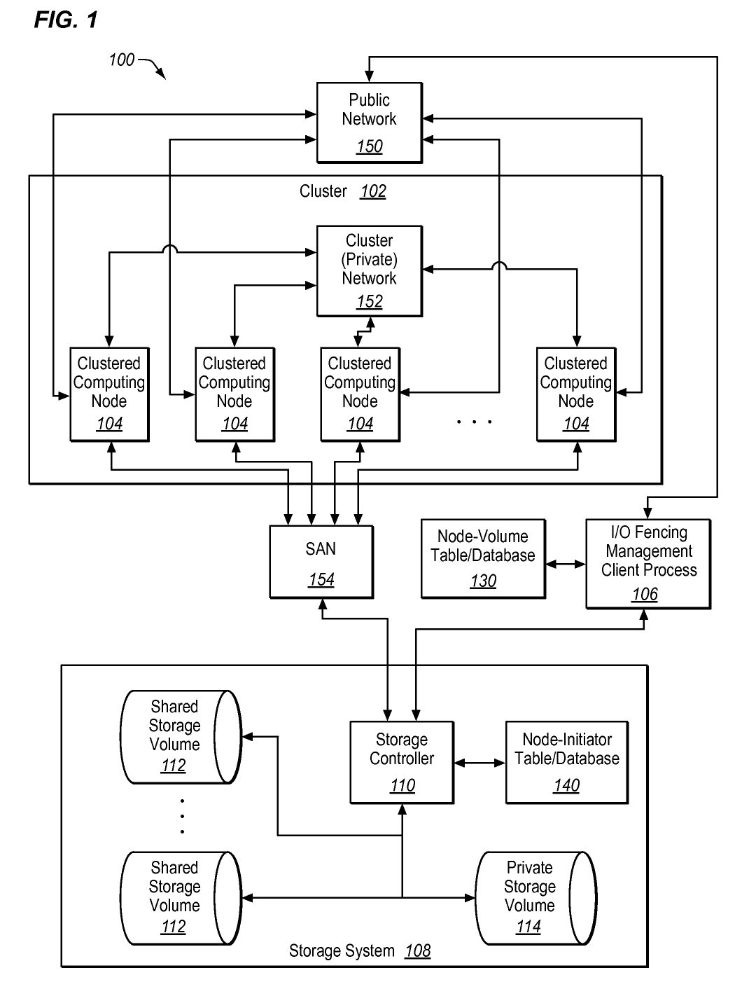

FIG. 1 is a block diagram of a system 100 embodying features and aspects hereof. System 100 includes cluster 102 comprising a plurality of clustered computing nodes 104. As is generally known in such clustered configurations, the clustered computing nodes 104 communicate among one another through a private or cluster network 152. This private cluster network coupling permits the clustered computing nodes 104 and associated cluster management software and applications (not shown) to perform cluster management functions such as load balancing and sharing among the various clustered computing nodes 104 so as to most efficiently perform assigned tasks. The details of such a clustered configuration are well known to those of ordinary skill in the art and a variety of commercially available cluster computing configurations are readily available. Cluster 102 generally communicates with client processes through a public network connection 150. Public network 150 permits client applications operable on client computing nodes (not shown) to access the computing resources and services of cluster 102. Thus, in general, cluster 102 may provide server functionality to perform requested computational functions on behalf of requesting client applications and computing nodes.

Cluster 102 (more specifically the clustered computing nodes 104 of cluster 102) are coupled to storage system 108 through Storage Area Network (“SAN”) 154. In general, cluster 102 may be coupled to a plurality of similar storage systems 108 each coupled to the cluster through one or more SAN 154 networks. A typical storage system 108 includes a storage controller 110 generally operable to manage operation of the storage system 108. Such management includes control of and interaction with disk drives associated with the storage system. Logical volumes are defined on the storage devices under control of the storage controller 110. Shared storage volumes 112 and private storage volumes 114 are examples of logical storage volumes that may be stored in the storage system 108. Storage controller 110 is also generally operable to perform I/O interaction through SAN 154 with attached computing nodes 104 of cluster 102.

As generally noted above, typical clustered computing configurations such as cluster 102 include a plurality of logical storage volumes 112 that are shared by multiple of the clustered computing nodes 104. Clustered computing nodes include cluster management software that helps coordinate the access by the multiple computing nodes 104 to the one or more shared volumes 112. In addition to the shared storage volumes, individual clustered computing nodes 104 may also define private storage volumes 114 accessible only to the associated, defining clustered computing node. For example, a clustered computing node 104 may be a diskless computing node such that the bootable device used to initialize the computing node is a private storage volume 114 stored on the storage system 108.

As noted above, it has been an ongoing challenge for such clustered computing environments with shared storage volumes to provide I/O fencing techniques and structures to flexibly and dynamically allow and disallow access to shared storage volumes responsive to detecting failure of a clustered computing node or responsive to detecting resumption of normal operation in a previously failed computing node of the cluster. In accordance with features and aspects hereof, system 100 includes an I/O fencing management client process 106 (also referred to herein as a collaboration management process” or as a “collaboration layer” or as a “collaboration module”) communicatively coupled with clustered computing nodes 104 of cluster 102 through public network 150 and communicatively coupled to storage controller 110 of each storage system 108. The I/O fencing management client process 106 is generally operable to detect a change in the operating status of the individual clustered computing nodes 104 of cluster 102 and to appropriately reconfigure operation of storage system 108 to dynamically allow or disallow access by a dysfunctional node 104 to one or more shared storage volumes 112 of the storage system. For example, if the I/O fencing management client process 106 detects a failure in a particular computing node 104 such that the computing node is now a dysfunctional computing note, I/O fencing client management process 106 communicates with storage controller 110 of storage system 108 to inform the storage system 108 that further access by the dysfunctional computing node should now be disallowed until further notice. In like manner, when I/O fencing management client process 106 detects that a previously dysfunctional computing node has resumed normal operation and thus is now a functional computing node, I/O fencing management client process 106 again communicates with storage system 108 to inform the storage system that access by the identified, now functional computing node may again be allowed.

In general, I/O fencing management client process 106 is operable to generate and update a database having tables containing information about the computing nodes' current operational status and information about the shared volumes to which each clustered computing node 104 desires access. When system 100 is initialized, I/O fencing management client process 106 may communicate with each of the clustered computing nodes 104 to determine which shared volumes 112 each computing node is required to access. As is well known in the art, subsets of the clustered computing nodes 108 may access certain of the shared storage volumes 112 and not require access to others other shared storage volumes 112. Thus, I/O fencing management client process 106 determines which volumes are utilized by each of the clustered computing nodes 104 and builds a database node-volume table 130 indicating the information so determined. The particular structure of such a table 130 will be readily apparent to those of ordinary skill in the art as a matter of design choice for a particular clustered environment. During initialization of system 100, I/O fencing management client process 106 also determines the list of initiator devices associated with each of the clustered computing nodes 104. As is generally known in the art, each clustered computing note 104 may include multiple, redundant communication paths or initiator devices for communicating through SAN 154 to storage system 108. Information identifying which initiator devices are associated with which clustered computing nodes is therefore gathered by I/O fencing management client process 106 and provided to storage system 108 for storage as database node-initiator table 140. The node-initiator table 140 may preferably be stored within storage system 108 to permit rapid access by storage controller 110. Thus, storage controller 110 may rapidly determine whether any particular initiator that provides a particular I/O request is associated with a computing node 104 known to be presently in a dysfunctional state such that the storage controller should deny access to shared storage volumes 112.

I/O fencing management client process 106 and its associated node-volume table 130 may be physically resident in any of several computing and/or storage devices. In one exemplary embodiment, I/O fencing management client process 106 and node-volume table 130 may be physically operable and resident in a management client computing node (not shown). Alternatively, the node-volume table 130 and the associated I/O fencing management client process may be distributed in a manner that is resident in a collaborative processing module or layer in each of the clustered computing nodes 104. A determination as to where the I/O fencing management client process 106 and the node-volume table 130 should reside and operate will be readily apparent as a matter of design choice for those of ordinary skill in the art. Since the node-volume table 130 is not frequently accessed, speed of access to the information stored therein is not likely critical. This table/database is only accessed when a particular node is sensed to be dysfunctional or is sensed to have resumed normal operation. The collaborative processing modules distributed in each clustered computing node or the centralized, stand-alone I/O fencing management client node would then access the node-volume table 130 to determine which storage systems should be informed of the change of operational status of the now dysfunctional computing node.

Those of ordinary skill in the art will readily recognize numerous additional and equivalent elements that may be present in a fully functional system 100. In particular, various additional components are common and well known in a fully functional cluster 102 and a storage system 108. Such additional elements are omitted herein for brevity and simplicity of this discussion and will be readily apparent to those of ordinary skill in the art. Still further, those of ordinary skill in the art will readily recognize that cluster 102 may include any desired number of cluster computing nodes 104. Further, SAN 154 may include any number of suitable network switching devices and communication paths including redundant switches and paths. Still further, each cluster computing node 104 may be coupled to SAN 154 by any desired number of communication paths for added redundancy and reliability. Still further, those of ordinary skill in the art will readily recognize that any number of storage systems 108 may be coupled to cluster 102 through SAN 154. Still further, each such storage system 108 may include redundant storage controllers 110 as well as redundant communication paths between each storage controller 110 and SAN 154. All such equivalent configurations will be readily apparent to those of ordinary skill in the art as a matter of design choice for the particular application.

Particular table and record structures for the node-volume table 130 and the node-initiator table 140 will be readily apparent to those of ordinary skill in the art as a matter of design choice. In general, each entry in the node-volume table 130 identifies a particular computing node as desiring access to a particular identified shared volume. The table may be indexed for rapid access as required by the node identifier and/or by the shared volume identifier. In general each entry of the node-initiator table 140 associates a particular initiator device with a particular node identifier for the computing node that contains that initiator device. In addition, information associated with each computing node in the table may provide the current level of access to be allowed or disallowed for all initiator devices associated with that identified computing node. Computing nodes, initiator device and shared volume may all be identified by any suitable identifier or address value that uniquely identifies the object in the clustered computing environment. For example, a shared volume may be identified by a name or other unique ID or address and may be associated with a storage system identified by a name, address or other unique identifier. The particular use of certain identifier values is a matter of design choice readily apparent to those of ordinary skill in the art.

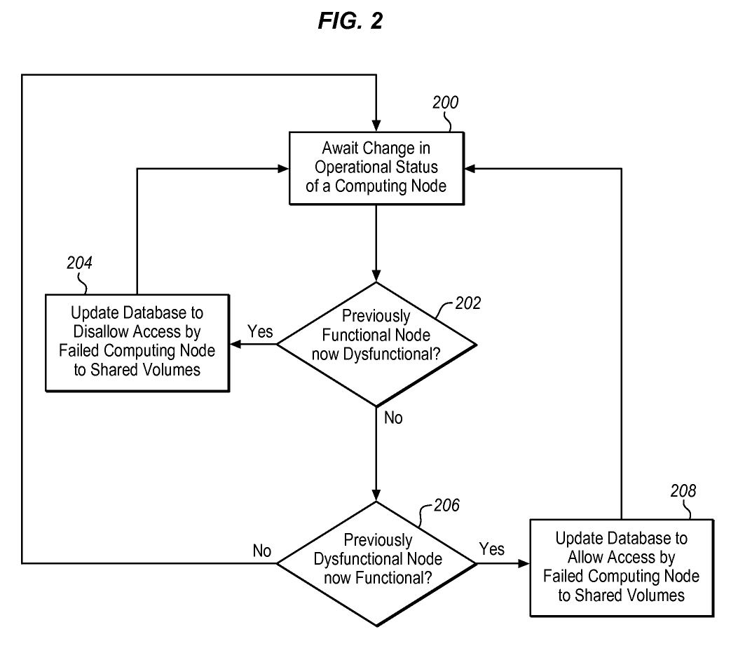

FIG. 2 is a flowchart describing an exemplary method in accordance with features and aspects hereof as may be operable in system 100 of FIG. 1. In general, the method of FIG. 2 may be operable in the I/O fencing management client process. Further as noted above, such a process may be distributed as a collaborative layer or module within each of the computing nodes or may be operable within a centralized management client computing node coupled to each of the clustered computing nodes. Whether so distributed or centralized, the method of FIG. 2 generally awaits the detection of a change in the operational status of a computing node and updates database tables appropriately to disallow or again allow access to shared volumes by the computing node whose operations status has changed.

Element 200 is therefore operable to await detection of a change in the operational status of the computing node of the cluster. In general, the operational status change to be detected is a change from a previously functional operating status to a now dysfunctional operating status or conversely a change from a previously dysfunctional operating status to a now functional operating status. As discussed above, a previously functional computing node that becomes a dysfunctional should be generally disallowed access to shared volumes to ensure continued reliability and integrity of the data on the shared volume. Conversely, a previously dysfunctional node that becomes again functional should be allowed to resume access to the shared volumes. Element 202 therefore determines whether the change in operational status is that of a previously functional node now becoming dysfunctional. If so, element 204 is then operable to update a database associated with the system to disallow further access by the identified failed computing node to identified shared volumes associated with the cluster. Processing then continues looping back to element 200 to await a next change in operational status of a computing node of the cluster.

If element 202 determines that the detected operational status change is not that of a functional node becoming dysfunctional, element 206 is then operable to determine whether the detected operational status change is that of a dysfunctional node becoming again fully operational and functional. If not, some other operational status change may have been detected that does not affect access to the shared volumes and may be appropriately processed (not shown). Processing continues looping back to element 200 to await a next change of operational status. If element 206 determines that a previously dysfunctional node has become again functional, element 208 is then operable to update database entries to again allow the identified, now functional computing node to access identified shared volumes associated with the cluster. Processing then continues looping back to element 200 to await detection of the next change in operational status of a computing node of the cluster.

Those of ordinary skill in the art will readily recognize numerous additional and equivalent method steps that may be associated with the method shown in FIG. 2. Such additional or equivalent method steps are omitted herein simply for brevity of this discussion but will be otherwise readily apparent to those of ordinary skill in the art.

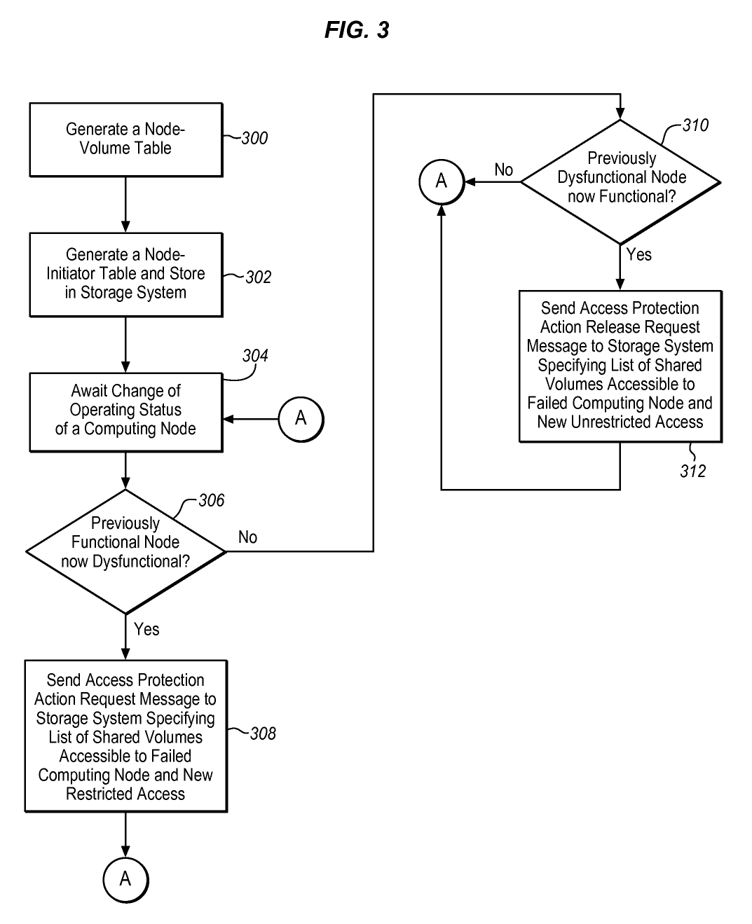

FIG. 3 is a flowchart further describing an exemplary method in accordance with features and aspects hereof. As above with respect to FIG. 2, the method of FIG. 3 is generally operable in the I/O fencing management client process. Further, as noted above, such a process may be distributed in a collaborative layer or module operable within each of the computing nodes of the cluster or may be operable in a standalone management client computing node. Such design choices for locating the processing of the management client process are well known to those of ordinary skill in the art. Regardless of its location, the method of FIG. 3 describes processing that utilizes a communicative coupling among each of the computing nodes of the cluster and communicative coupling with the storage system to generate and maintain database tables useful in managing the I/O fencing operation.

Element 300 is first operable to generate a node table indicating which shared volumes within the storage system are intended to be accessible to each of the computing nodes of the cluster. As noted above, entries in such a node-volume table may identify the storage system storing a shared volume by a suitable ID and/or address and may identify the particular shared volume within that storage system by a particular ID and/or address. Thus, in general, entries of the node-volume table associate each computing node with the one or more shared volumes to which the associated computing node may require access. As noted above, the node-volume table may be stored in a variety of physical locations. Where the I/O fencing management client process is operable within a standalone computing node, the volume node-volume table may be stored in local mass storage associated with that stand-alone management computing node. Where the I/O fencing management client process is distributed through a collaboration layer or module in each of the computing nodes of the cluster, each such computing node may access the node-volume table in a shared volume on the storage system or may maintain its own private copy of the node-volume table following initial generation thereof. Since the node-volume table changes relatively infrequently in a typical application of cluster computing nodes coupled to a storage system, the table may be duplicated in each of the multiple collaboration layers or modules operable within the multiple computing nodes of the cluster. In addition, as noted above, the table is relatively rarely accessed (e.g., upon detection of the change in operational status of one of the computing nodes of the cluster). Thus, speed of access to the node-volume table is not a critical factor in performance of the entire system.

Element 302 is then operable to generate a node-initiator table wherein each entry identifies all of the initiator devices associated with a particular computing node of the cluster. In addition, the node-initiator table may be used to store the present access permission associated with each initiator of each computing node. Since such a table storing the present access permission for each initiator of each node may be frequently accessed by storage controllers of the storage system, the table should preferably be readily available to programmed instructions and other logic circuits of the storage controller for rapid access. In particular, as discussed further herein below, this table may be queried upon receipt of each I/O request from a computing node of the cluster. The table should therefore be readily accessible to the storage controller of the storage system to permit rapid determination as to the access permitted by the particular initiator of a particular computing node generating the received I/O request. Therefore, in a preferred embodiment, the node-initiator table is preferably stored within the storage system. The node-initiator table may be stored within the mass storage devices of the storage system or within higher speed RAM memory (volatile or non-volatile) associated with the storage controllers of the storage system.

Element 304 is then operable to await a detected change of operating status of one of the computing nodes of the cluster. As noted above, most relevant operational status changes include that of a change from functional to dysfunctional status and the inverse change from dysfunctional to functional operational status. Element 306 is then operable to determine whether the detected operational status change of a computing node is that of a previously functional node now detected to be dysfunctional. If so, element 308 is then operable to send an access protection action request message from the I/O fencing management client process to the storage system. The access protection action request message preferably includes a list of shared volumes and an indication of the computing node now detected as dysfunctional. The storage system in receipt of such a message may then update the node-initiator table stored within the storage system to indicate that the identified computing node should be disallowed access to the list of shared volumes received in the message. Further, as noted above, the access protection action request message may also indicate whether the protection desired is for disallowing any further access (read or write) by the identified computing node to the identified list of shared volumes or whether the access to be disallowed is only write access. Element 308 is therefore operable to update the node-initiator table to reflect the desired level of access (if any) remaining to be allowed by the identified computing node as regards the identified list of shared volumes. Processing then continues looping back to element 304 to await detection of a next change of operational status in a computing node of the cluster.

If element 306 determines that the detected operational status change in a computing node is not that of a previously functional node now becoming dysfunctional, element 310 is operable to determine whether the detected operational status change is that of the previously dysfunctional computing node now becoming functional (e.g., a resumption of normal operational status of the identified computing node). If not, processing continues looping back to element 304 to await detection of the next change of operational status in a computing node of the cluster. If so, otherwise, element 312 is operable to send an access protection action release request message from the I/O fencing management client process to the storage system. As above with regard to the action request message, the access protection action release request message identifies the computing node that has resumed its normal, functional operational status and also includes a list of shared volumes to which the now functional computing node may be restored access. As noted above with regard to the action request message, the action release request message may also identify particular levels of access that may be again allowed to the identified, now functional computing node for the identified list of shared volumes. In other words, access may be restored to the identified computing node in phases such that first read access may be restored and then a subsequent request may provide full read/write access by the now functional computing node to the list of shared volumes. Processing continues looping back to element 304 to await detection of a next change of operating status in a computing node of the cluster.

Those of ordinary skill in the art will readily recognize numerous additional and equivalent method steps that may be incorporated in the method of FIG. 3 as a matter of design choice. Such additional and equivalent elements are omitted herein for simplicity and brevity of this discussion.

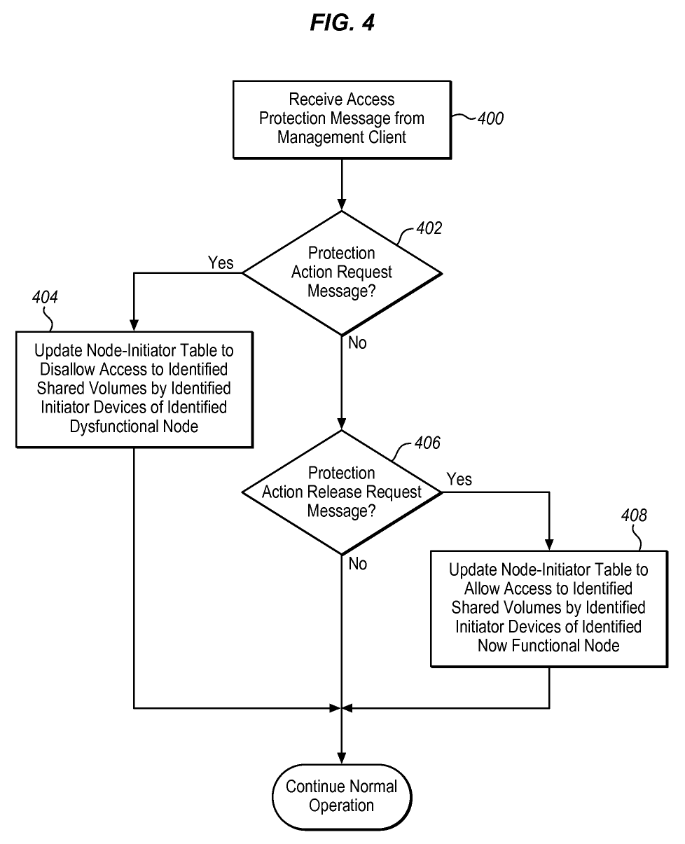

FIG. 4 is a flowchart describing an exemplary method in accordance with features and aspects hereof operable within the storage system responsive to receipt of an access protection related message as described above with respect to FIG. 3. As noted above, the I/O fencing management client process may generate access protection related messages indicating an action to be performed or released regarding protection of identified shared volumes from access by associated identified computing nodes. Element 400 is first operable to receive an access protection message from the client I/O fencing management client process. Element 402 is then operable to determine whether the received protection related request message is an action request message. If so, processing continues with element 404 to update the node-initiator table stored within the storage system to disallow further access to the identified list of shared volumes by the identified initiator devices of the identified dysfunctional computing node in the cluster. As noted above, the action request message may indicate particular forms of access to be denied to the indicated dysfunctional computing node. For example, the action may deny only write access or may deny all read/write access to the identified list of volumes. Processing then continues with normal operation of the storage system utilizing the updated information in the node-initiator table. If element 402 determines that the received access protection message is not an action request, element 406 is operable to determine whether the received message is an action released request message. If so, element 408 is operable similar to element 404 to update the node-initiator table accordingly. In particular, the identified, previously dysfunctional node that is now properly functional is allowed access to the identified list of shared volumes. As indicated above with regard to element 404, the particular access to be again allowed may be limited only to read access or may be indicate allowance of full read/write access to the list of shared volumes. In all cases, processing continues with normal operation of the storage controller to process I/O requests in accordance with the updated information in the node-initiator table.

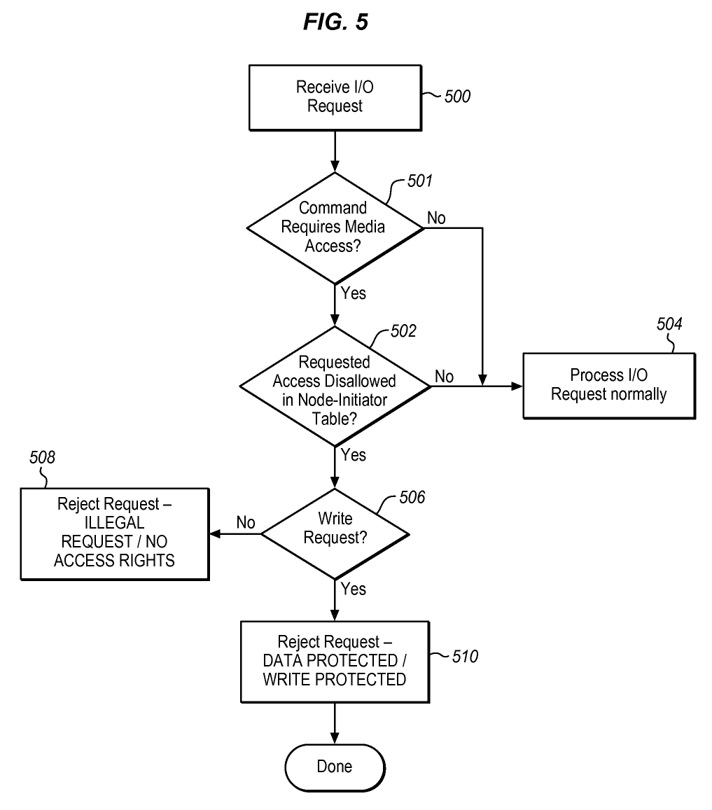

FIG. 5 is a flowchart representing an exemplary method in accordance with features and aspects hereof operable within the storage system to process I/O requests in accordance with access information in the node-initiator table. Element 500 represents receipt of an I/O request within the storage controller of the storage system. Element 501 first determines if the I/O request (e.g., the SCSI command) requires access to the storage medium—i.e., for reading or writing of data. If no media access is required, processing continues with element 504 to complete the request normally—i.e., the restricted permissions need not be queried to complete such a command that requires no media access. Otherwise, element 502 then determines whether the node initiator table indicates that the identified initiator of the identified node in the received I/O request is presently permitted the requested access to the identified shared volume in the I/O request. More specifically, element 502 is operable to determine if read access to the storage medium is permitted if the I/O request from the initiator device is a read request (e.g., determine whether read-only or read/write access permitted). Similarly, if the I/O request is a write request, element 502 is operable to determine if write access is permitted to the storage medium by the requesting initiator (e.g., read/write access is permitted).

If the node/initiator sending the received I/O request is disallowed the requisite access processing continues at element 506 to further process the rejection of the request by returning an appropriate rejection of the request. If the requested access is available to the identified shared volume by the requesting node/initiator, element 504 is next operable to process the received I/O request normally. In other words if the node-initiator table indicates that there are no restrictions on the requested access, normal I/O processing may proceed. Such normal I/O processing of an I/O request is well known to those of ordinary skill in the art and need not be discussed further herein. Processing of the method of FIG. 5 then completes awaiting restart in response to receipt of yet another I/O request from a computing node of the cluster.

If element 502 determines that the requisite level of access has been disallowed for the requesting computing node/initiator as indicated by the node-initiator table, element 506 then determines whether the request is for write access to the identified shared volume. If not, element 508 is operable to reject the received I/O request with an appropriate status indicator. For example, in a serial attached SCSI (“SAS”) or other SCSI environment, the request may be rejected with a status code indicating an ILLEGAL REQUEST and a sub code indicating that NO ACCESS RIGHTS are granted for the requested read access. Processing of the method of FIG. 5 is then completed and awaits restarting responsive to receipt of another I/O request. If however element 506 determines that the I/O request is for write access to a shared volume, element 510 is operable to reject the received I/O request with an appropriate status code. As above in the context of a SAS or other SCSI interface environment, the request may be rejected with a status code of DATA PROTECTED and a sub code indicating that the data is WRITE PROTECTED. The method of FIG. 5 thereby completes awaiting restart by receipt of a new I/O request.

Those of ordinary skill in the arts will readily recognize a variety of additional and equivalent method steps that may be included in the methods of FIGS. 4 and 5. Such equivalent and additional steps are eliminated herein for simplicity and brevity of this discussion.

While the invention has been illustrated and described in the drawings and foregoing description, such illustration and description is to be considered as exemplary and not restrictive in character. One embodiment of the invention and minor variants thereof have been shown and described. Protection is desired for all changes and modifications that come within the spirit of the invention. Those skilled in the art will appreciate variations of the above-described embodiments that fall within the scope of the invention. In particular, those of ordinary skill in the art will readily recognize that features and aspects hereof may be implemented equivalently in electronic circuits or as suitably programmed instructions of a general or special purpose processor. Such equivalency of circuit and programming designs is well known to those skilled in the art as a matter of design choice. As a result, the invention is not limited to the specific examples and illustrations discussed above, but only by the following claims and their equivalents.

What is claimed is:

1. A system comprising:
a cluster comprising a plurality of computing nodes communicatively coupled to one another;
a storage system comprising a plurality of shared volumes;
a storage area network (“SAN”) communication channel coupling the storage system to the cluster;
a database comprising information regarding shared volumes in the storage system and comprising information regarding the plurality of computing nodes;
a collaboration management process associated with the cluster and associated with the storage system and coupled to the database,
wherein the collaboration management process is adapted to sense a change of the operational state of a computing node of the cluster and is further adapted to update the database to indicate which shared volumes are accessible to each of the plurality of computing nodes, and
wherein the storage system is communicatively coupled to the database and wherein the storage system is adapted to allow and disallow access to a shared volume by a particular computing node based on information in the database.

2. The system of claim 1
wherein the collaboration management process is adapted to sense a change of status of a computing node between a functional status and a dysfunctional status,
wherein the collaboration management process is adapted to update the database to indicate that the computing node cannot access a shared volume while the computing node is in a dysfunctional status, and
wherein the collaboration management process is adapted to update the database to indicate that the computing node can access a shared volume while the computing node is in a functional status.

3. The system of claim 2
wherein the storage system is adapted to disallow access to a shared volume by a computing node for which information in the database indicates that the computing node cannot access the shared storage volume.

4. The system of claim 2
wherein the collaboration management process is adapted to update the database to indicate that the computing node in a dysfunctional status cannot write to the shared volume, and
wherein the storage system is adapted to disallow write access to the shared volume by the computing node in a dysfunctional status and allow read access to the shared volume by the computing node in a dysfunctional status.

5. The system of claim 1
wherein the database is stored on the storage system.

6. The system of claim 1
wherein the database comprises:
a node-initiator table that identifies each communication link associated with each computing node; and
a node-volume table that identifies each shared volume accessible to each computing node.

7. The system of claim 6
wherein the node-initiator table is stored in the storage system.

8. The system of claim 1
wherein the collaboration management process is operable within a management client node communicatively coupled to the cluster and communicatively coupled to the storage system.

9. A method operable in a cluster computing enterprise, the enterprise including a cluster of computing nodes each coupled to a storage system, the storage system comprising a plurality of shared volumes controllably accessible by the cluster of computing nodes, the method comprising:
detecting failure of a computing node of the cluster;
updating a table accessible by the storage system to indicate the failed status of the computing; and
disallowing access by the failed computing node to the shared volumes of the storage system based on updated information in the table.

10. The method of claim 9 further comprising:
detecting resumption of proper operation of a previously failed computing node;
updating the table to indicate resumption of proper operation of the previously failed computing node; and
allowing access by the previously failed computing node to the shared volumes based on updated information in the table.

11. The method of claim 10
wherein the steps of updating are performed by a client process communicatively coupled to the storage system and communicatively coupled to the cluster of computing nodes.

12. The method of claim 9
wherein the table is stored in the storage system.

13. The method of claim 9
wherein the step of disallowing further comprises disallowing write access to the shared volumes by the failed computing node.

14. The method of claim 9
wherein the step of disallowing further comprises disallowing read/write access to the shared volumes by the failed computing node.

15. The method of claim 9
wherein the step of updating further comprises:
sending an access protection message to the storage system from a management client coupled to the storage system and coupled to the cluster of computing nodes.

16. The method of claim 15
wherein the step of sending further comprises:
sending an access protection action request message to the storage system in response to detecting failure of a dysfunctional computing node of the cluster wherein the access protection action request identifies one or more shared volumes of the storage system to which the dysfunctional computing node is to be denied access; and
sending an access protection action release request message to the storage system in response to detecting resumption of proper operation of a previously dysfunctional computing node of the cluster wherein the access protection action release request identifies one or more shared volumes of the storage system to which the failed computing node is to be allowed access.

17. A method operable in a system including a storage system coupled to a cluster of computing nodes, the storage system including a plurality of shared volumes, the method comprising:
generating a node-volume table wherein each entry in the node-volume table corresponds to a computing node of the cluster and wherein the entry further indicates the shared volumes to which the node-volume table entry's corresponding computing node requires access;
generating a node-initiator table stored in the storage system wherein each entry in the node-initiator table corresponds to a computing node of the cluster and wherein each entry further indicates all initiator devices associated with the corresponding computing node used by the node-initiator table entry's corresponding computing node to communicate with the storage system;
detecting the operating status of a computing node of the cluster;
responsive to detecting failed operating status of a previously functional computing node of the cluster, configuring the storage system to disallow access to one or more shared volumes of the storage system by any initiator devices associated with the now dysfunctional computing node; and
responsive to detecting resumption of normal operating status of a previously dysfunctional computing node of the cluster, configuring the storage system to allow access to one or more shared volumes of the storage system by any initiator devices associated with the now functional computing node,
wherein the steps of configuring utilize information in the node-initiator table and utilize information in the node-volume table.

18. The method of claim 17
wherein the step of detecting and the steps of configuring are performed by a management client node coupled to the storage system and coupled to the cluster of computing nodes.

19. The method of claim 18
wherein the step of configuring to allow access further comprises sending a message from the management client node to the storage system to configure the storage system to allow access to identified shared volumes by the now functional computing node.

20. The method of claim 18
wherein the step of configuring to disallow access further comprises sending a message from the management client node to the storage system to configure the storage system to disallow access to identified shared volumes by the dysfunctional computing node.
